(19) United States
(12) Patent Application Publication
(10) Pub. No.: US 2017/0101983 A1
(43) Pub. Date: Apr. 13, 2017

(54) PENDULUM POWERED ENERGY AND WATER DEVICES AND METHOD

(71) Applicant: Allen Mark Jones, Imperial Beach, CA (US)

(72) Inventor: Allen Mark Jones, Imperial Beach, CA (US)

(21) Appl. No.: 15/291,977

(22) Filed: Oct. 12, 2016

Related U.S. Application Data
(60) Provisional application No. 62/240,105, filed on Oct. 12, 2015.

(51) Int. Cl. F03G 3/06; F25D 21/14; F25D 19/00; F04D 17/10

(52) U.S. Cl. CPC F03G 3/06; F04D 17/10; F25D 21/14; F25D 19/00

(57) ABSTRACT

The embodiments disclose a method including operating at least one pendulum module coupled to at least one anti-dampening module for regulating oscillations, operating at least one pendulum driven dynamic compressor module for compressing air using rotational power produced using at least one pendulum module, using the at least one pendulum driven dynamic compressor module compressed air for rotating at least one rotating ring dynamic compressor module to a predetermined rotational speed for dynamically compressing air to a predetermined pressure, regulating the dynamically compressed air for operating at least one compressed air driven piston electric generator module for generating electricity, operating at least one chiller water vapor condensation module for dewatering ambient air drawn by the rotating at least one rotating ring dynamic compressor module, operating water treatment modules for treating the chiller produced water, and scrubbing carbon dioxide from the compressed air and storing the carbon dioxide for non-release uses.

### CROSS-REFERENCE TO RELATED APPLICATIONS

This application is based on U.S. Provisional Patent Application Ser. No. 62/240,105 filed Oct. 12, 2015. Entitled “PENDULUM POWERED ENERGY AND WATER DEVICES AND METHOD”, by Allen Mark Jones.

### BACKGROUND

Technologies to generate electricity primarily rely on the use fuels and natural conditions including solar and wind to provide a motive force. Fuel supplies can be exhausted and fuel resources can be depleted. Natural conditions including solar and wind vary in intensity and cannot be relied upon to provide a constant motive force.

### BRIEF DESCRIPTION OF THE DRAWINGS

FIG. 1 shows a block diagram of an overview flow chart of pendulum powered energy and water devices and method of one embodiment.

FIG. 2 shows a block diagram of pendulum powered energy and water devices and method pendulum module of one embodiment.

FIG. 3 shows a block diagram of a pendulum driven dynamic compressor of one embodiment.

FIG. 4 shows a block diagram of a ring dynamic compressor module of one embodiment.

FIG. 5 shows for illustrative purposes only an example of pendulum dampening of one embodiment.

FIG. 6 shows for illustrative purposes only an example of at least one pendulum anti-dampening module of one embodiment.

FIG. 7 shows for illustrative purposes only an example of at least one pendulum driven dynamic compressor module drive module of one embodiment.

FIG. 8A shows for illustrative purposes only an example of at least one horizontal ring dynamic compressor pulley belt track section of one embodiment.

FIG. 8B shows for illustrative purposes only an example of at least one horizontal ring dynamic compressor inlet and storage convex sliding section of one embodiment.

FIG. 8C shows for illustrative purposes only an example of at least one horizontal ring dynamic compressor concave sliding channel section of one embodiment.

FIG. 8D shows for illustrative purposes only an example of at least one horizontal ring dynamic compressor base section of one embodiment.

FIG. 9 shows for illustrative purposes only an example of at least one horizontal ring dynamic compressor assembly of one embodiment.

FIG. 10A shows for illustrative purposes only an example of at least one vertical single ring dynamic compressor assembly drive side view of one embodiment.

FIG. 10B shows for illustrative purposes only an example of at least one vertical single ring dynamic compressor assembly collection side view of one embodiment.

FIG. 11A shows for illustrative purposes only an example of at least one vertical nine ring dynamic compressor assembly drive side view of one embodiment.

FIG. 11B shows for illustrative purposes only an example of at least one vertical nine ring dynamic compressor assembly collection side view of one embodiment.

FIG. 12 shows for illustrative purposes only an example of at least one portable pendulum powered energy and water devices and method container unit of one embodiment.

### DETAILED DESCRIPTION OF THE INVENTION

In a following description, reference is made to the accompanying drawings, which form a part hereof, and in which is shown by way of illustration a specific example in which the invention may be practiced. It is to be understood that other embodiments may be utilized and structural changes may be made without departing from the scope of the embodiments.

### General Overview:

It should be noted that the descriptions that follow, for example, in terms of a pendulum powered energy and water devices and method is described for illustrative purposes and the underlying system can apply to any number and multiple types pendulums, compressors, condensers and other components of a pendulum powered energy and water devices and method. In one embodiment, the pendulum can be configured using a horizontal ring dynamic compressor. In one embodiment, the pendulum can be configured using a vertical ring dynamic compressor. The pendulum powered energy and water devices and method can be configured to include a building installation and can be configured to include a portable container installation using the embodiments.

The world is in search of solutions to nagging problems that in some cases have been haunting mankind throughout its history. Clean renewable energy that is economical and dependable in every location without depleting natural resources and do not pollute the air we breathe. Water that can sustainably be produced in quantities that support agriculture and domestic needs without stressing natural resources including aquifers and rivers. Cost effective reduction of greenhouse gases from the atmosphere and utilizing those sequestered gases in beneficial non-release processes.

The pendulum powered energy and water devices and method produces a constant motive force to drive electric generators 24 hours a day that is self-contained, sustainable and independent of the use of greenhouse emitting fuels and uncontrollable natural conditions including solar and wind.

The pendulum powered energy and water devices and method is a scalable system that generates clean renewable electricity without the use of fossil fuels, solar or wind, produces water is scalable quantities to deliver untreated water for agricultural, commercial and industrial uses and deliver treated potable water for domestic uses, and sequesters carbon dioxide from the ambient air for uses in non-release processes including agricultural and industrial processes. The small footprint and independence from fuels and natural conditions of pendulum powered energy and water devices and method allows installations at any location including within parking garages, interior of building and other locations not exposed to wind, solar and ambient conditions.

The pendulum powered energy and water devices and method utilizes the power generated by gravity in a pendulum application to compress air for use in other integral systems to compress extensive quantities of air to drive the operation of electric generators. The innovative dynamic compressor designs have few moving parts which reduces maintenance, and reduces the amount of power needed to compress air. Air supplied to the compressors is processed through condensers to condense water vapor (humidity) from the ambient air and collect the liquid water for additional filtration and treatment processing for domestic and other uses. The air once compressed is processed for sequestration of carbon dioxide. The sequestered carbon dioxide is concentrated and collected in removable vessels for delivery to other facilities for non-release applications that include for example agriculture and carbon fiber production.

Gravitational oscillation of a pendulum is diminished by friction at the pivot point and aerodynamic drag of the pendulum bob movement through the surrounding air. The pendulum loses force on each swing through the friction and drag dampening of the swing distance.

The pendulum powered energy and water devices and method includes at least one anti-dampening apparatus to add additional oscillation force to counter-act the friction and drag reduction in force. This allows the pendulum to maintain a constant magnitude of oscillation.

The pendulum powered energy and water devices and method compressed air is pressure regulated from the higher compression psi to a lower working psi for operation of the electric generators. The decompression to a lower pressure lowers the temperature of the compressed air. A chiller apparatus uses the lowered temperature to process coils with cooled fluid to the condenser units and along with blower units lowers the temperature of the air being processed below the dew point and condenses the water vapor into a liquid.

Treatment processes filter and treat the liquid water to potable quality standards for delivery of domestic water. Untreated water is filtered and available for delivery to farm fields, hydroponic cultivation, industrial processing and refilling of depleted reservoirs and aquifers.

The scalability of the pendulum powered energy and water devices and method allows deliveries of electricity in ranges of 30 kW to over 150 MW. Water deliveries range from 1 acre foot per year to over 30,000 acre feet per year.

The pendulum powered energy and water devices and method portable container installation can be used in multiple applications. The pendulum powered energy and water devices and method portable container installation can be alternatively described herein as a pendulum power and water container unit. The pendulum power and water container unit can easily be trucked or shipped to remote sites to serve applications including remote villages, embassy compounds, disaster relief services, mobile military units, fire-fighting efforts and other venues where space and time are in short supply. The pendulum power and water container unit can begin supplying electricity and water within the hour of delivery. The pendulum power and water container unit can be built quickly and available in large numbers.

Disaster relief power and water can be quickly delivered to the hard hit area where power lines are down and water supplies disrupted or contaminated. A fleet of trucks with pendulum power and water container units can deliver immediate sources of clean power and water to the affected populations and refugee centers to support the medical and humanitarian aid with a constant supply of electricity for lighting, cooking, medical equipment, recharging cell phones. Clean treated potable water will be readily available to further the rescue efforts.

Trucks with pendulum power and water container units can circulate within the effected neighborhoods to make power and water available to those staying in their homes. When utility workers get sections of power lines standing and safely connected the pendulum power and water container units can be used to energize those sections of power lines until normal service is reestablished.

The planned siting of the pendulum powered energy and water devices and method installation is to avoid a large central facility in favor of smaller facilities distributed throughout a region. The reason is to avoid the need for larger water mains for distribution of the water produced and the use of transmission lines to distribute the electricity. The water production can be sized to allow feeding the treated potable water directly into adjacent existing water mains. The testing of the water quality will conform to local water agency specifications or better. This will eliminate any additional pumping cost and construction of new water lines from distant water sources.

Likewise production of electricity can be sized to local substation capacities and distribution circuit voltages and amperage capacities. An interconnection to those local lines can eliminate further stressing aging transmission lines, long distance energy losses and/or the construction cost of new transmission lines. In addition with both water and electricity the distributed generation of new water and electricity sources will help prevent regional outages and blackouts and lengthy disruptions in water deliveries due to water main breaks.

The pendulum powered energy and water devices and method can be used for a solution to droughts. Using the California drought for an example, The California State Water Resources Control Board in the June 2014-July 2015 Urban Water Supplier Report shows production of water by local water agencies and deliveries to populations in their hydrologic regions have fallen approximately 14% from the previous year. A Pacific Institute August 2015 report shows a 30% drop in water deliveries for agriculture from 2005 to 2013.

The economic impact of this extended drought is costing California thousands of jobs, lost production in agriculture and other industries, major changes in the California life style and consuming State resources for conservation efforts that could certainly be of help in other areas.

This has proven to be one of the worst droughts suffered in the State. But it is not the first nor will it be the last. As populations rise we have seen, here to now taken for granted, aquifers and rivers depleted in some cases to a point of no return. Heroic efforts are being carried out to prevent infiltration of seawater into coastal aquifers. At the current rates of surface and ground water withdrawals it will take abnormally high rainfall and snow pack over decades to produce annual water needs and at the same time replenish the depleted resources. Given the historical climate data that is unlikely.

The pendulum powered energy and water devices and method is a new water source that does not pump surface or ground water. Pendulum powered energy and water devices and method can amply meet current needs and allow Mother Nature to work her magic to replenish the natural water resources. Pendulum powered energy and water devices and method can even be of aid to Mother Nature. For one example out of hundreds, Castaic Lake located in Los Angeles County has a maximum capacity of 320,000 acre-feet. As of Sep. 15, 2014 it was only 38 percent full. The drought depleted 198,400 acre foot of stored water. This depletion could be replenished in less than 7 years with the use of a pendulum powered energy and water devices and method unit producing 30,000 acre feet a year in less time with multiple installations. Restrictions on recreational fishing, boating and other uses could be lifted and the fear of a repeat in another drought would be wiped away.

Over time other lakes and reservoirs can be refilled using pendulum powered energy and water devices. Rivers again will be able to follow normal flows. Hydroelectric dams will have enough water to generate electricity. Agricultural and livestock production regions will be able to grow, harvest and raise livestock without losing crops and animals due to a lack of water. Homeowners will be able to maintain their manicured landscaping, fill their swimming pools and play golf on green grass. Regions around the world will be able to escape the constant water problems that have plagued those region though out time and have even caused “Water Wars”.

The pendulum powered energy and water devices and method can end current droughts and prevent the disastrous results of future droughts. The pendulum powered energy and water devices and method can quickly allow regions to reduce costly and greenhouse gas emitting power production and reach their goals of greater renewable energy levels.

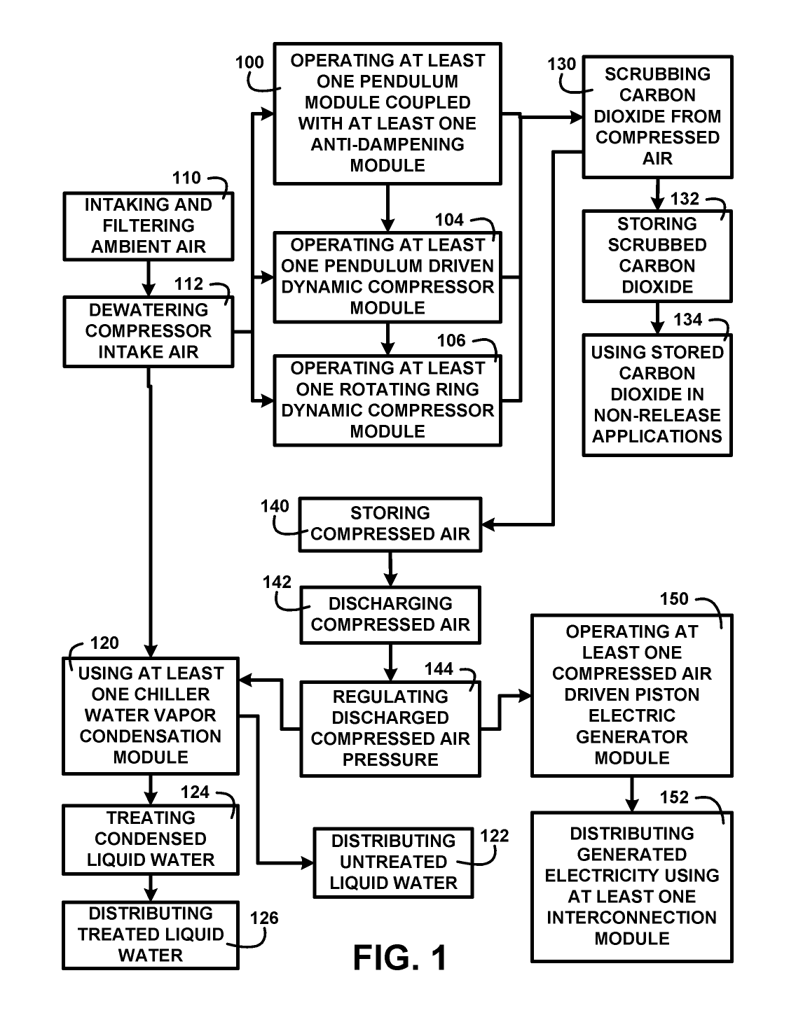

FIG. 1 shows a block diagram of an overview flow chart of pendulum powered energy and water devices and method of one embodiment. FIG. 1 shows a process step operating at least one pendulum module coupled with at least one anti-dampening module 100. The at least one pendulum module back and forth oscillation will lose gravity energy due to aerodynamic drag and pivot friction. The at least one anti-dampening module is used to impart an energy impulse equal to the drag and friction energy loss to maintain a constant oscillation.

The at least one pendulum module oscillation drives a pendulum connection rod for operating at least one pendulum driven dynamic compressor module 104. The pendulum connection rod is coupled to a pendulum driven dynamic compressor module pulley offset cam to rotate a pendulum driven pulley for operating at least one pendulum driven dynamic compressor module 104. The pendulum pulley transfers rotation to at least one pendulum driven dynamic compressor module. The rotation of the at least one pendulum driven dynamic compressor drives dewatered ambient air into at least one receiving inlet of a first cross-section area of a pendulum driven dynamic compressor compression chamber. The pendulum driven dynamic compressor compression chamber is tampered to a lesser second cross-section area outlet coupled to a compressed air collection pipe. The tampering of the compression chamber reduces the volume of incoming dewatered ambient air thereby compressing the air to a greater pressure. The compressed air flows through the compressed air collection pipe for storing compressed air 140 into a storage module. The outlet flow of the compressed air creates a vacuum that draws dewatered ambient air into a pendulum driven dynamic compressor module intake cabinet. The dewatered ambient air has been processed in steps including intaking and filtering ambient air 110 using at least one chiller water vapor condensation module 120 in a process for dewatering compressor intake air 112. Condensed water using at least one chiller water vapor condensation module 120 can be used in distributing untreated liquid water 122. Treating condensed liquid water 124 can produce potable water for distributing treated liquid water 126. Scrubbing carbon dioxide from compressed air 130 reduces the levels of greenhouse gases in the atmosphere and storing scrubbed carbon dioxide 132 allows using stored carbon dioxide in non-release applications 134. Storing compressed air 140 then discharging compressed air 142 including regulating discharged compressed air pressure 144 can be used for example for operating at least one compressed air driven piston electric generator module 150. Electrical panels and equipment is used for distributing generated electricity using at least one interconnection module 152 of one embodiment of the present invention.

### Detailed Description:

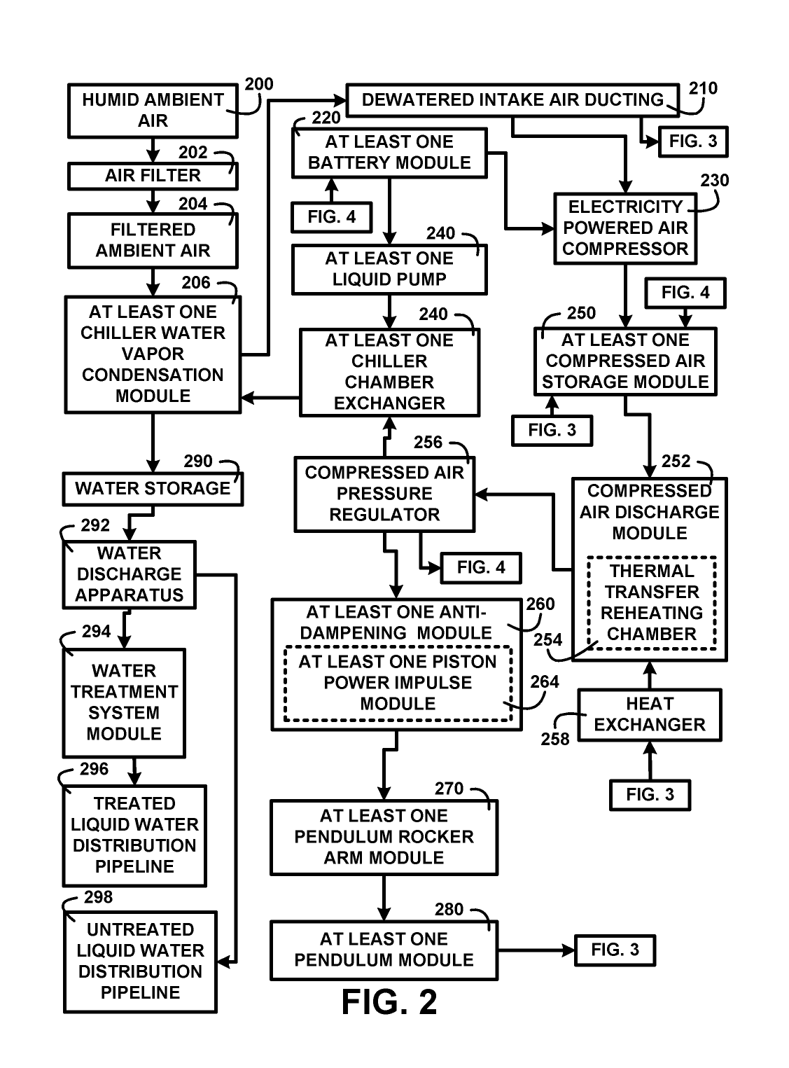

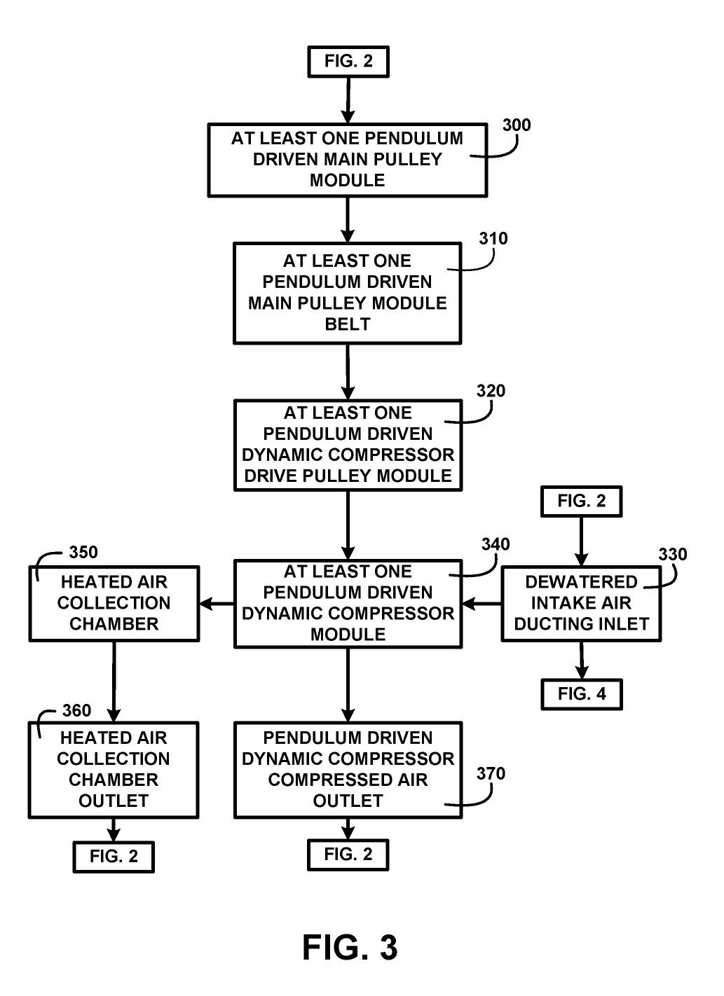

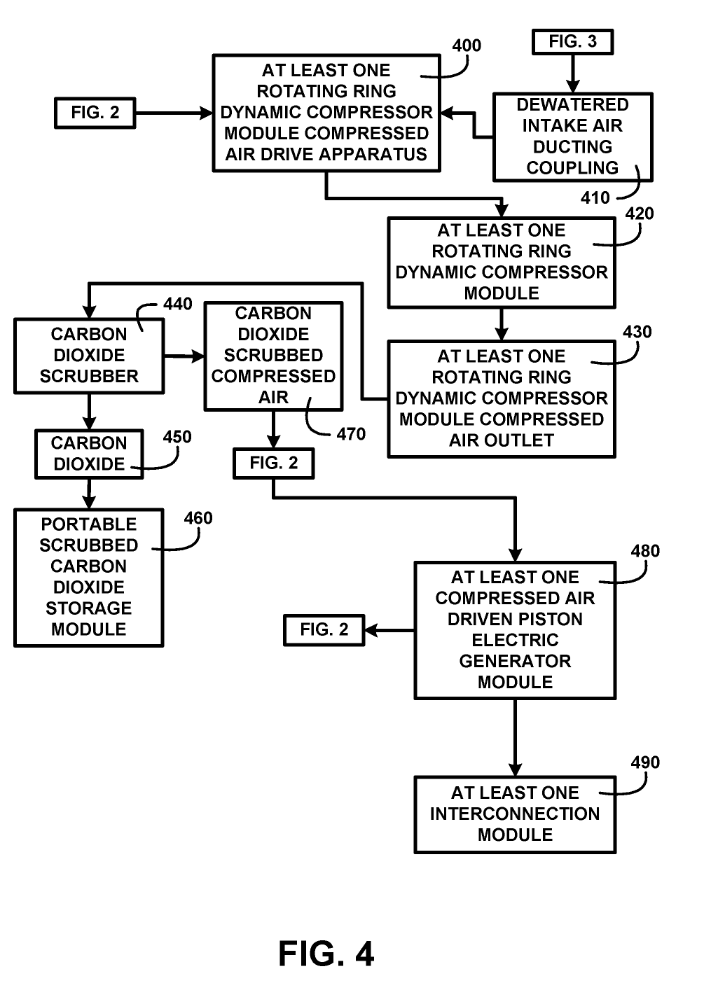

FIG. 2 shows a block diagram of a pendulum powered energy and water devices and method pendulum module of one embodiment. FIG. 2 shows at least one battery module 220 with recharging described in FIG. 4. The at least one battery module 220 is used for operating at least one electricity powered air compressor 230 for compressing air in ranges of pressure from 300 psi to 6,000 psi. The compressed air is conveyed and contained in at least one compressed air storage module 250. At least one compressed air discharge module 252 passes the compressed air through a heat exchanger 258. Heat transfer from the heat exchanger 258 is used in a thermal transfer reheating chamber 254 for example to regulate the discharged compressed air pressure as described in FIG. 3. A compressed air pressure regulator 256 is used as described in FIG. 4. The regulated compressed air is used in at least one anti-dampening module 260 including at least one piston power impulse module 264 coupled to at least one pendulum rocker arm module 270 coupled to at least one pendulum module 280 described in FIG. 3. The at least one battery module 220 can provide power to operate at least one liquid pump 240 coupled to at least one chiller chamber exchanger 240 for conveying liquid water. At least one chiller water vapor condensation module 206 includes at least one dewatered intake air ducting 210 used for drawing humid ambient air 200 through at least one air filter 202. Filtered ambient air 204 passes through at least one chiller water vapor condensation module 206 including at least one chiller chamber exchanger 240 for lowering temperatures of the filtered ambient air 204 below a dew point temperature to condense water vapor in the filtered ambient air 204. The condensed water vapor changes states to a liquid. The liquid water is collected in a water storage 290 module. At least one water discharge apparatus 292 includes at least one untreated liquid water distribution pipeline 298. A water treatment system module 294 is used to treat water pumped using the at least one liquid pump 240 and into at least one treated liquid water distribution pipeline 296 of one embodiment.

FIG. 3 shows a block diagram of a pendulum driven dynamic compressor of one embodiment. FIG. 3 shows continuing from FIG. 2 at least one pendulum driven main pulley module 300 and at least one pendulum driven main pulley module belt 310. The at least one pendulum driven main pulley module belt 310 is used to transfer rotation to at least one pendulum driven dynamic compressor drive pulley module 320. Dewatered air from FIG. 2 is conveyed through at least one dewatered intake air ducting inlet 330 to at least one pendulum driven dynamic compressor module 340. The at least one pendulum driven dynamic compressor module 340 dynamically compresses air and discharges the compressed air through at least one pendulum driven dynamic compressor compressed air outlet 370. The at least one pendulum driven dynamic compressor module 340 includes a heated air collection chamber 350 to collect heat from the compression and discharges the heat through a heated air collection chamber outlet 360 of one embodiment.

FIG. 4 shows a block diagram of a ring dynamic compressor module of one embodiment. FIG. 4 shows at least one rotating ring dynamic compressor module compressed air drive apparatus 400 that draws dewatered air through a dewatered intake air ducting coupling 410. The at least one rotating ring dynamic compressor module compressed air drive apparatus 400 is used to operate at least one rotating ring dynamic compressor module 420. The at least one rotating ring dynamic compressor module 420 dynamically compresses air which is discharged through at least one rotating ring dynamic compressor module compressed air outlet 430. Compressed air is passed through a carbon dioxide scrubber 440 to sequester carbon dioxide 450 which is contained in at least one portable scrubbed carbon dioxide storage module 460.

A carbon dioxide scrubber 440 can be configured to include passing the dynamically compressed air through at least one activated carbon adsorbent bed module for sequestering carbon dioxide gas. A carbon dioxide scrubber 440 can be configured to include passing the dynamically compressed air through at least one zeolite adsorbent bed module. Carbon dioxide scrubbed compressed air 470 is pressure regulated and used to operate at least one compressed air driven piston electric generator module 480. The at least one compressed air driven piston electric generator module 480 generated electricity is conducted to an electric panel and at least one interconnection module 490 for deliver to users of one embodiment.

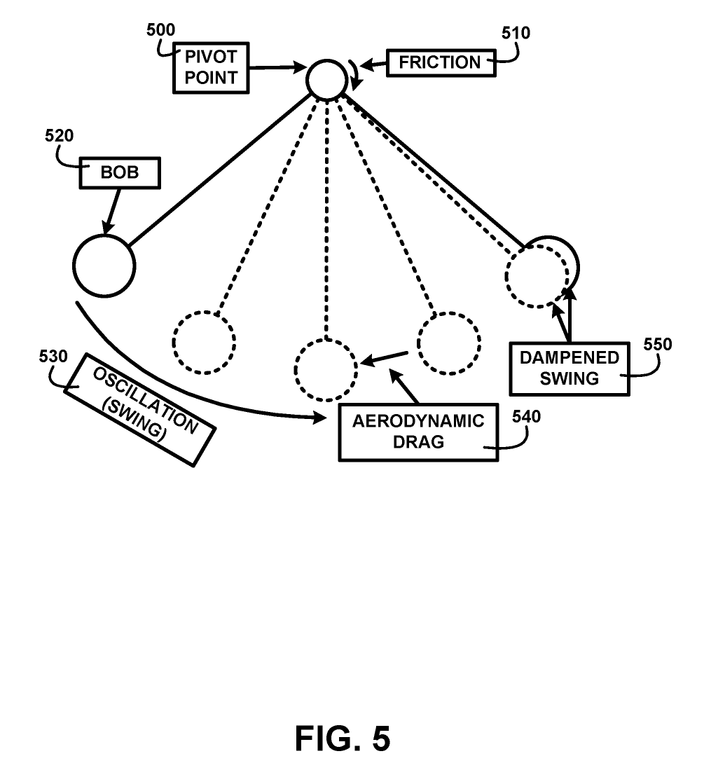

FIG. 5 shows for illustrative purposes only an example of pendulum dampening of one embodiment. FIG. 5 shows a pendulum pivot point 500 where friction 510 occurs during pendulum oscillations. A pendulum bob 520 as it oscillates is slowed due to aerodynamic drag 540. During each pendulum oscillation (swing) 530 slowing caused by friction 510 and aerodynamic drag 540 decreases an amount of oscillation energy and is referred to as a dampened swing 550 which without intervention will continue to slow the oscillations until the pendulum stops of one embodiment.

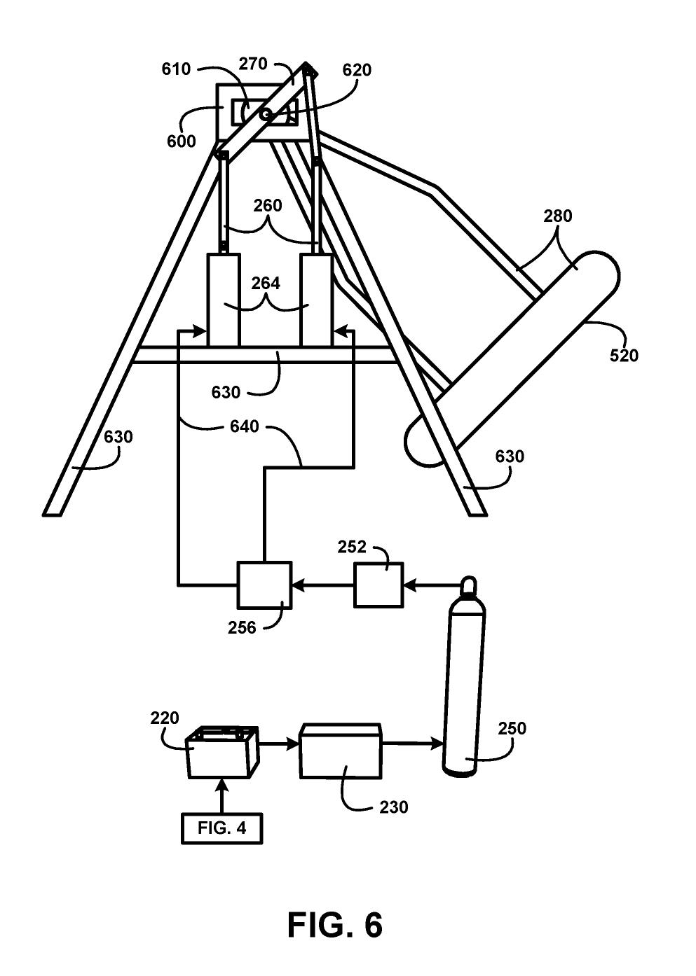

FIG. 6 shows for illustrative purposes only an example of at least one pendulum anti-dampening module of one embodiment. FIG. 6 shows from FIG. 4 recharging of at least one battery module 220 used to operate at least one electricity powered air compressor 230. The compressed air produced by the at least one electricity powered air compressor 230 is conveyed to at least one compressed air storage module 250. The compressed air discharge module 252 processes the compressed air through the compressed air pressure regulator 256 to regulate the pressure of compressed air that is passed through anti-dampening compressed air supply piping 640 to at least one anti-dampening module 260. The at least one anti-dampening module 260 includes at least one piston power impulse module 264 which receives a predetermined volume of compressed air to add energy to the pendulum oscillation to counteract the dampening. The at least one piston power impulse module 264 is coupled to at least one pendulum rocker arm module 270 coupled to at least one pendulum module 280 transferring the added energy to the bob 520. The at least one pendulum rocker arm module 270 is coupled to the pivot axle 620 of the at least one pendulum module 280. This coupling applies the at least one anti-dampening module 260 added energy to a pivot bearing 610 housed in a pivot bearing module 600 mounted near the top of the pendulum support structure 630 of one embodiment.

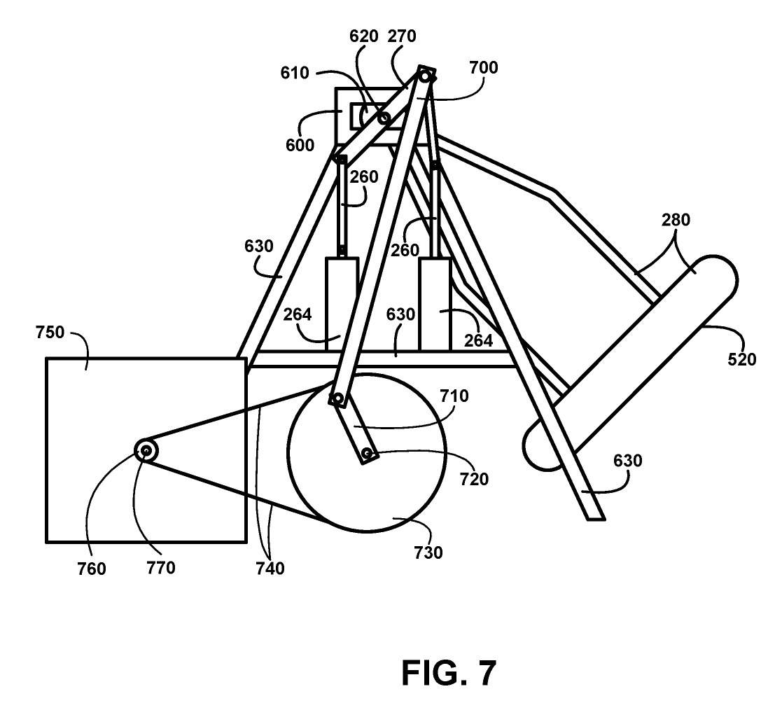

FIG. 7 shows for illustrative purposes only an example of at least one pendulum driven dynamic compressor module drive module of one embodiment. FIG. 7 shows at least one anti-dampening module 260, at least one piston power impulse module 264, at least one pendulum rocker arm module 270, at least one pendulum module 280, pivot bearing module 600, pivot bearing 610, pivot axle 620, pendulum support structure 630 and bob 520. Coupled to the at least one pendulum rocker arm module 270 is at least one pendulum pulley drive arm 700 coupled at the opposite terminus to a pendulum pulley cam 710. The at least one pendulum pulley drive arm 700 transfers oscillation swing to the pendulum pulley cam 710 to rotate a pendulum pulley 730 about a pendulum pulley axle 720. Coupled to the pendulum pulley axle 720 is a pendulum pulley 730 coupled to a pendulum pulley belt 740 coupled in the loop to at least one pendulum driven dynamic compressor module drive pulley 760. The pendulum pulley belt 740 transfers rotation of the pendulum pulley 730 to the at least one pendulum driven dynamic compressor module drive pulley 760. The at least one pendulum driven dynamic compressor module drive pulley 760 rotates about at least one pendulum driven dynamic compressor module axle 770. The rotation of the at least one pendulum driven dynamic compressor module axle 770 rotates and operates at least one pendulum driven dynamic compressor module 340 coupled to the at least one pendulum driven dynamic compressor module axle 770 for dynamically compressing air of one embodiment.

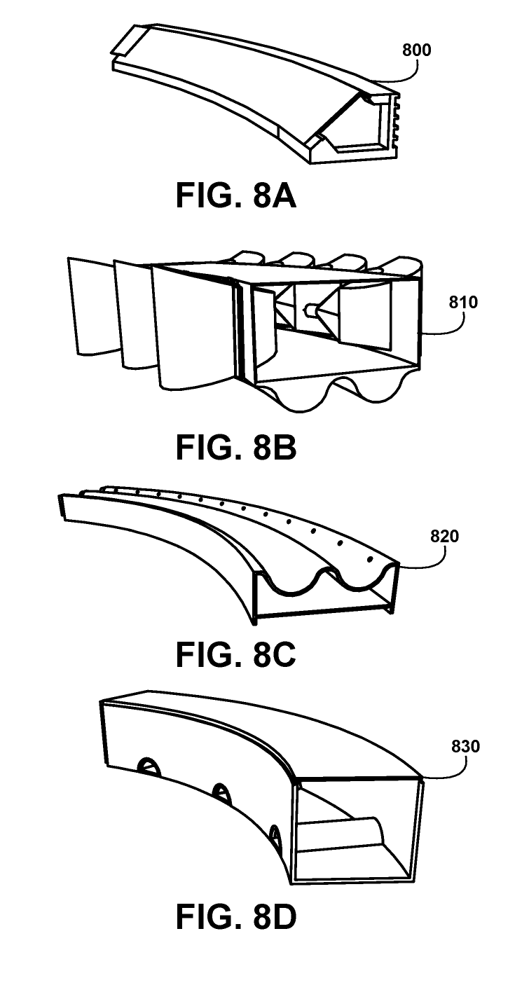

FIG. 8A shows for illustrative purposes only an example of at least one horizontal ring dynamic compressor pulley belt track section of one embodiment. FIG. 8A shows at least one horizontal ring dynamic compressor pulley belt track section 800 used in an assembly to hold in position and support a pulley belt used to transfer rotation to other devices including other dynamic compressors and air handling devices of one embodiment.

FIG. 8B shows for illustrative purposes only an example of at least one horizontal ring dynamic compressor inlet and storage convex sliding section of one embodiment. FIG. 8B shows at least one horizontal ring dynamic compressor inlet and storage convex sliding section 810 used in an assembly to channel dynamically compressed air into a storage chamber integrated within the at least one horizontal ring dynamic compressor inlet and storage convex sliding section 810 structure. The compressed air flows from the storage chamber through piping to other storage containment devices, pressure regulation devices, electric generator piston drive modules, compressed air driven devices and other compressed air uses and devices. The convex structure integrated within the at least one horizontal ring dynamic compressor inlet and storage convex sliding section 810 structure is used to support the at least one horizontal ring dynamic compressor inlet and storage convex sliding section 810 assembly on a fluid while sliding on a concave complementary structure of one embodiment.

FIG. 8C shows for illustrative purposes only an example of at least one horizontal ring dynamic compressor concave sliding channel section of one embodiment. FIG. 8C shows at least one horizontal ring dynamic compressor concave sliding channel section 820 used in an assembly to contain a fluid on which the at least one horizontal ring dynamic compressor inlet and storage convex sliding section 810 of FIG. 8B slides during rotational movement. The at least one horizontal ring dynamic compressor concave sliding channel section 820 structure forms an integrated chamber used to store the sliding fluid which is drawn from the integrated chamber into the concave well through syphon holes of one embodiment.

FIG. 8D shows for illustrative purposes only an example of at least one horizontal ring dynamic compressor base section of one embodiment. FIG. 8D shows at least one horizontal ring dynamic compressor base section 830 used in an assembly to store compressed air and support other horizontal ring dynamic compressor sections and other devices coupled to, above and on top of the at least one horizontal ring dynamic compressor base section 830. Compressed air from the at least one horizontal ring dynamic compressor base section 830 flows through piping to at least one collection device for conveyance to other devices including piping through openings integrated in a lower level of the at least one horizontal ring dynamic compressor base section 830 of one embodiment.

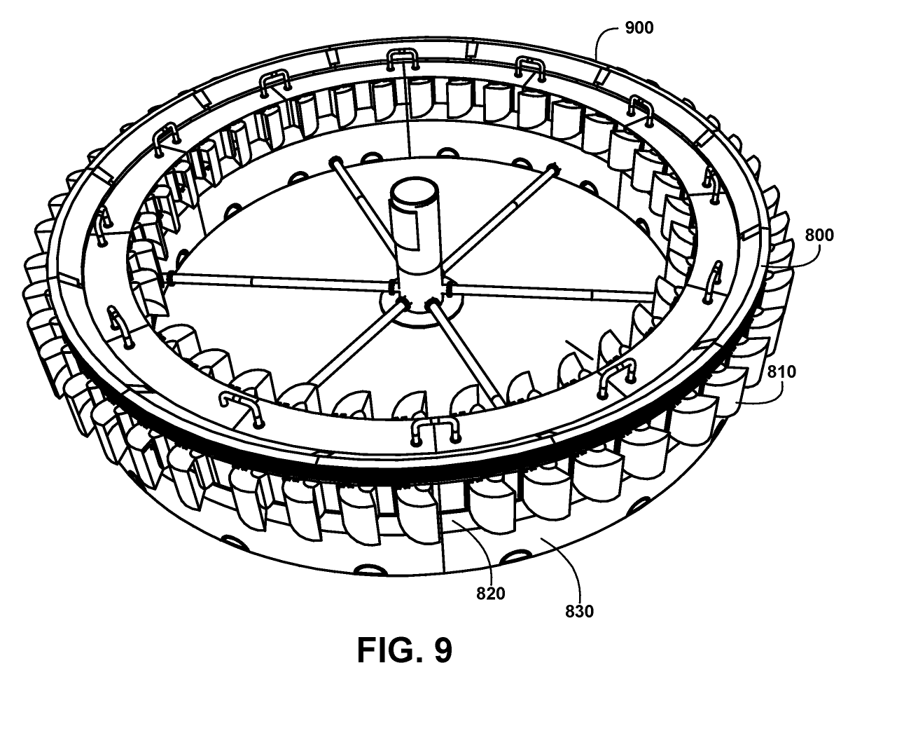

FIG. 9 shows for illustrative purposes only an example of at least one horizontal ring dynamic compressor assembly of one embodiment. FIG. 9 shows at least one horizontal ring dynamic compressor assembly 900 including at least one horizontal ring dynamic compressor pulley belt track section 800, at least one horizontal ring dynamic compressor inlet and storage convex sliding section 810, at least one horizontal ring dynamic compressor concave sliding channel section 820, and at least one horizontal ring dynamic compressor base section 830 of one embodiment. The at least one horizontal ring dynamic compressor pulley belt track section 800 and at least one horizontal ring dynamic compressor inlet and storage convex sliding section 810 operates using compressed air created using the at least one pendulum module 280 of FIG. 2 and at least one pendulum driven dynamic compressor module 340 of FIG. 3 to rotate the sliding sections at a predetermined rotational speed to dynamically compress air to a predetermined pressure.

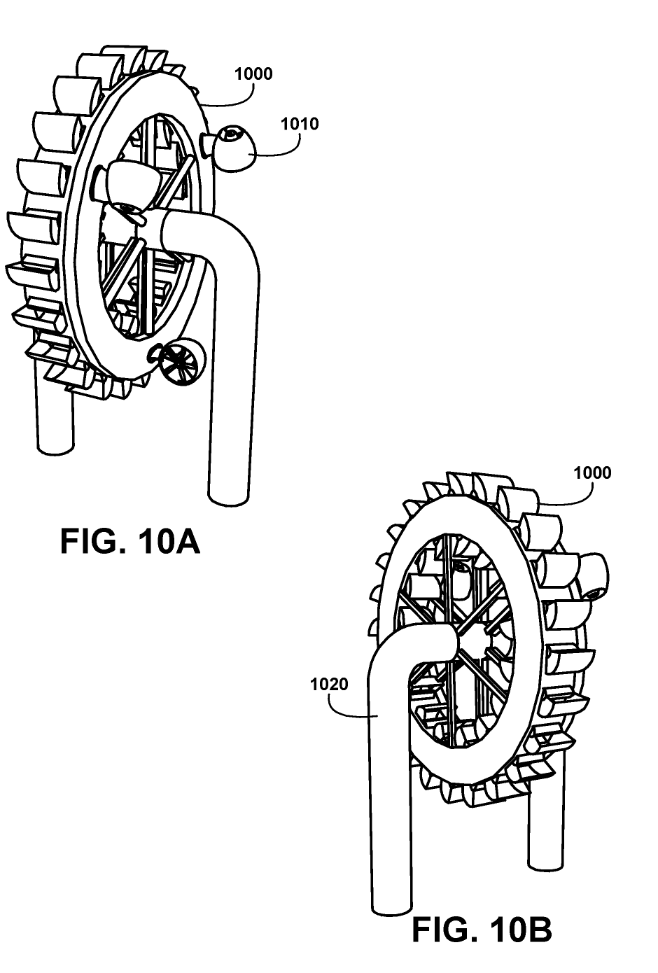

FIG. 10A shows for illustrative purposes only an example of at least one vertical single ring dynamic compressor assembly drive side view of one embodiment. FIG. 10A shows at least one vertical single ring dynamic compressor module 1000 in an assembly including a piston drive module 1010. The piston drive module 1010 operates using compressed air created using the at least one pendulum module 280 of FIG. 2 and at least one pendulum driven dynamic compressor module 340 of FIG. 3 to rotate the at least one vertical single ring dynamic compressor assembly 1000 at a predetermined rotational speed to dynamically compress air to a predetermined pressure of one embodiment.

FIG. 10B shows for illustrative purposes only an example of at least one vertical single ring dynamic compressor assembly collection side view of one embodiment. FIG. 10B shows at least one vertical single ring dynamic compressor module 1000 in an assembly including a compressed air collection piping module 1020 used to convey compressed air to compressed air storage containment devices, pressure regulation devices, electric generator piston drive modules, compressed air driven devices and other compressed air uses and devices of one embodiment.

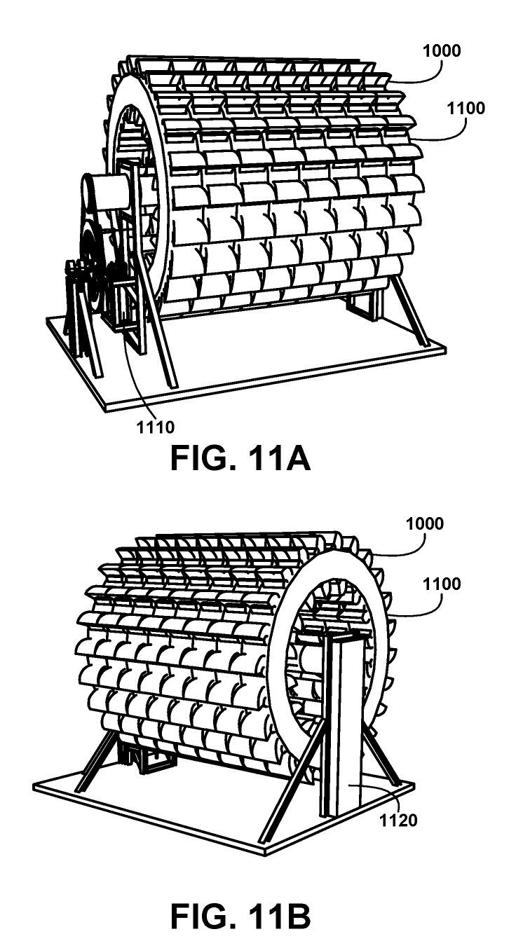

FIG. 11A shows for illustrative purposes only an example of at least one vertical nine ring dynamic compressor assembly drive side view of one embodiment. FIG. 11A shows at least one vertical nine ring dynamic compressor assembly 1100 including nine at least one vertical single ring dynamic compressor module 1000 and a piston driven drive module 1110. The piston driven drive module 1110 operates using compressed air created using the at least one pendulum module 280 of FIG. 2 and at least one pendulum driven dynamic compressor module 340 of FIG. 3 to rotate the at least one vertical single ring dynamic compressor assembly 1000 at a predetermined rotational speed to dynamically compress air to a predetermined pressure of one embodiment.

FIG. 11B shows for illustrative purposes only an example of at least one vertical nine ring dynamic compressor assembly collection side view of one embodiment. FIG. 11B shows at least one vertical nine ring dynamic compressor assembly 1100 including nine at least one vertical single ring dynamic compressor module 1000 and a compressed air collection ducting module 1120 used to convey compressed air to compressed air storage containment devices, pressure regulation devices, electric generator piston drive modules, compressed air driven devices and other compressed air uses and devices of one embodiment.

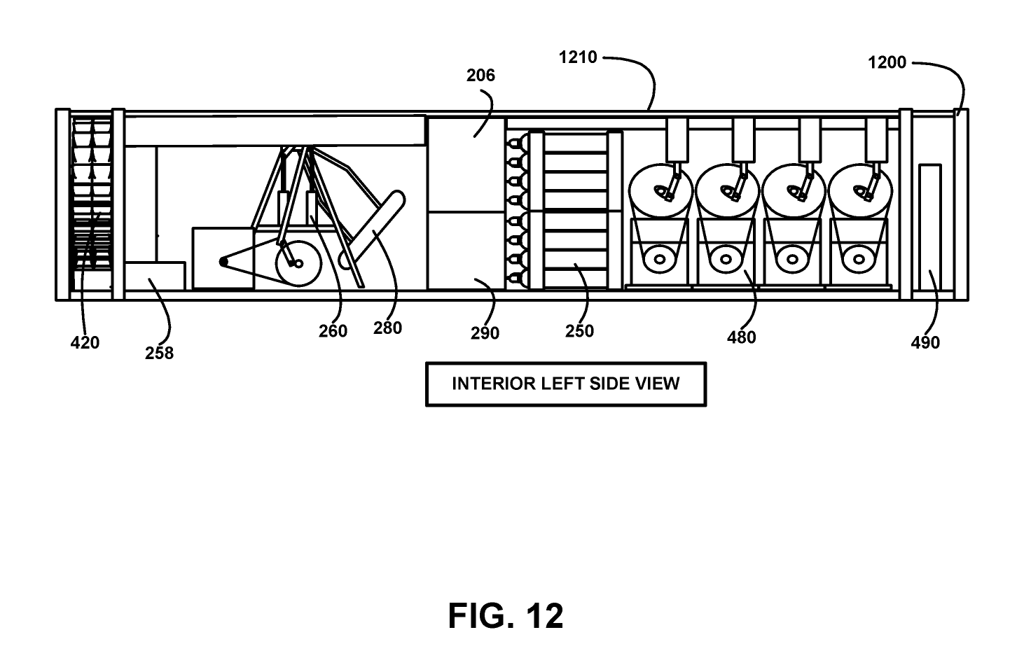

FIG. 12 shows for illustrative purposes only an example of at least one portable pendulum powered energy and water devices and method container unit of one embodiment. FIG. 12 shows an interior view of a container with doors, roof panel and wall panels not showing 1200. The container includes at least one chiller water vapor condensation module 206, at least one pendulum driven dynamic compressor module, at least one rotating ring dynamic compressor module 420, a heat exchanger 258, at least one pendulum module 280, at least one anti-dampening module 260, water storage 290, at least one compressed air storage module 250, at least one compressed air driven piston electric generator module 480, and at least one interconnection module 490 creating a portable containerized pendulum powered energy and water device 1210 of one embodiment.

In one embodiment the pendulum powered energy and water devices and method includes operating at least one pendulum module 280 coupled to at least one anti-dampening module 260 for regulating oscillations; using the at least one pendulum module 280 oscillations to create rotational motion in at least one pendulum pulley 730; operating at least one pendulum driven dynamic compressor module 104 housed in a dewatered air intake cabinet using the at least one pendulum module 280 produced at least one pendulum pulley 730 rotational motion for dynamically compressing air and storing the dynamically compressed air in at least one compressed air storage module 250; rotating at least one rotating ring dynamic compressor module compressed air drive apparatus housed in a dewatered air intake cabinet using compressed air released from the at least one compressed air storage module 250 to a predetermined pressure to regulate a predetermined rotational speed for dynamically compressing air to a predetermined pressure and storing the dynamically compressed air in at least one compressed air storage module 250; creating a vacuum within at least one dewatered air intake cabinet using an outlet flow of compressed air; creating an inlet flow of dewatered air from at least one chiller water vapor condensation module to fill the vacuum created in at least one dewatered air intake cabinet; regulating an outlet pressure of the dynamically compressed air released from the at least one compressed air storage module 250 to a reduced pressure for operating at least one compressed air driven piston electric generator module for generating electricity, rotating the at least one rotating ring dynamic compressor module compressed air drive apparatus, operating at least one liquid pump for pumping the at least one chiller water vapor condensation module produced liquid water, operating the at least one anti-dampening module 260 and operating at least one liquid pump for circulating a fluid in at least one chiller water vapor condensation module; operating the at least one chiller water vapor condensation module for dewatering ambient air drawn in through the inlet flow of dewatered air to fill the vacuum created in the at least one dewatered air intake cabinet for producing liquid water; operating at least one water treatment system module 294 for treating the at least one chiller water vapor condensation module produced liquid water; sequestering carbon dioxide gas using at least one carbon dioxide scrubber 440 from the dynamically compressed air and storing the carbon dioxide gas in removable vessels for non-release uses; and; housing pendulum powered energy and water modules and devices in a container for creating at least one portable containerized pendulum powered energy and water device 1210.

In another embodiment the at least one anti-dampening module 260 is configured for determining a value of the at least one pendulum module 280 dampened force reduction on each swing and configured for imparting an additional force equal to the determined value of the dampened force reduction for regulating oscillations of the at least one pendulum module 280. In yet another embodiment the at least one pendulum driven dynamic compressor module 104 is configured for conveying compressed air into the at least one compressed air storage module 250. In an embodiment the at least one rotating ring dynamic compressor module compressed air drive apparatus is configured for conveying compressed air into the at least one compressed air storage module 250. In one embodiment the compressed air in the at least one compressed air storage module 250 is configured for discharging compressed air through a pressure regulator for regulating the pressure to outflow piping. In another embodiment the at least one pendulum driven dynamic compressor module 104 and the at least one rotating ring dynamic compressor module compressed air drive apparatus are configured to be housed in separate dewatered air intake cabinets. An embodiment includes the at least one pendulum driven dynamic compressor module 104 and the at least one rotating ring dynamic compressor module compressed air drive apparatus configured for creating a vacuum within at least one dewatered air intake cabinet causing an air flow through the at least one chiller water vapor condensation module to fill the vacuum created and the at least one chiller water vapor condensation module is configured to channel the vacuum created air flow to pass over condensation coils containing a chilled flow to reduce the air temperature to or below the dew point to cause water vapor to condense into a liquid. An embodiment includes a temperature exchanger for regulating the outlet pressure of the dynamically compressed air released from the at least one compressed air storage module 250 to a reduced pressure reduces temperatures of the released compressed air and the reduced pressure released compressed air is configured to pass through the temperature exchanger configured for chilling a fluid flowing through piping coils of the temperature exchanger. In one embodiment the at least one anti-dampening module 260 is configured for injecting into at least one piston power impulse module 264 drive compressed air from the at least one compressed air storage module 250 at a regulated pressure to add a force driving a piston and piston rod for applying an additional force to at least one pendulum rocker arm module 270 coupled to at least one pendulum module 280 to transfer a force to the at least one pendulum module 280 to counteract a predetermined value of a dampening force reduction for regulating oscillations of the at least one pendulum module 280 to an initial full oscillation swing. In another embodiment the at least one anti-dampening module 260 is configured to include at least one piston power impulse module 264 configured to include a double acting piston module for counteracting a dampening force reduction for regulating oscillations of the at least one pendulum module 280.

In one embodiment the pendulum powered energy and water devices and method includes an apparatus, comprising at least one pendulum module 280 coupled to at least one anti-dampening module 260 configured for regulating oscillations; at least one pendulum module 280 configured for converting at least one pendulum module 280 oscillations to rotational motion in at least one pendulum pulley 730; at least one pendulum driven dynamic compressor module 104 housed in a dewatered air intake cabinet configured for compressing air using rotational power produced in the at least one pendulum pulley 730; at least one compressed air storage module 250 configured for storing and releasing compressed air from at least one pendulum driven dynamic compressor module 104; at least one rotating ring dynamic compressor module compressed air drive apparatus compressed air drive apparatus 400 housed in a dewatered air intake cabinet configured for using compressed air from the at least one compressed air storage module 250 for rotating at a predetermined rotational speed for dynamically compressing air to a predetermined pressure; at least one compressed air storage module 250 coupled with at least one pressure regulator configured for storing compressed air and releasing compressed air at one or more regulated pressures; at least one electric generator module configured to operate using at least one compressed air driven piston drive using pressure regulated compressed air released from the at least one compressed air storage module 250; at least one chiller water vapor condensation module configured for dewatering ambient air drawn by the at least one pendulum driven dynamic compressor module 104 and at least one rotating ring dynamic compressor module compressed air drive apparatus compressed air drive apparatus 400 and configured for producing liquid water; at least one water treatment system module 294 configured for treating the liquid water produced by the at least one chiller water vapor condensation module; at least one carbon dioxide scrubber 440 configured for sequestering carbon dioxide gas from dynamically compressed air from the at least one pendulum driven dynamic compressor module 104 and at least one rotating ring dynamic compressor module compressed air drive apparatus compressed air drive apparatus 400 and configured for storing the sequestered carbon dioxide gas in removable vessels for non-release uses; and; housing pendulum powered energy and water modules and devices in a container for creating at least one portable containerized pendulum powered energy and water device 1210.

In another embodiment the at least one anti-dampening module 260 is configured for determining a value of the at least one pendulum module 280 dampened force reduction on each swing and configured for imparting an additional force equal to the determined value of the dampened force reduction for regulating oscillations of the at least one pendulum module 280. An embodiment includes the at least one pendulum driven dynamic compressor module 104 configured for conveying compressed air into the at least one compressed air storage module 250. In an embodiment the at least one rotating ring dynamic compressor module compressed air drive apparatus is configured for conveying compressed air into the at least one compressed air storage module 250. In another embodiment the at least one anti-dampening module 260 is configured for injecting into at least one piston power impulse module 264 drive including at least one double acting piston power impulse module drive compressed air from the at least one compressed air storage module 250 at a regulated pressure to add a force driving a piston and piston rod for applying an additional force to at least one pendulum rocker arm module 270 coupled to at least one pendulum module 280 to transfer a force to the at least one pendulum module 280 for regulating oscillations and to counteract a dampening force reduction.

In one embodiment the pendulum powered energy and water devices and method includes an apparatus, comprising at least one pendulum module 280; at least one anti-dampening module 260 coupled to the at least one pendulum module 280; at least one pendulum module 280 configured for converting at least one pendulum module 280 oscillations to rotational motion in at least one pendulum pulley 730; at least one pendulum driven dynamic compressor module 104 housed in a dewatered air intake cabinet and configured for dynamically compressing air using rotational power produced in the at least one pendulum pulley 730; at least one compressed air storage module 250 configured for storing dynamically compressed air and releasing pressure regulated dynamically compressed air; at least one rotating ring dynamic compressor module compressed air drive apparatus compressed air drive apparatus 400 housed in a dewatered air intake cabinet configured for rotating at a predetermined rotational speed for dynamically compressing air to a predetermined pressure; at least one compressed air storage module 250 coupled with at least one pressure regulator configured for storing dynamically compressed air and releasing pressure regulated dynamically compressed air; at least one electric generator module configured for using pressure regulated dynamically compressed air for operating at least one compressed air driven piston drive for operating; at least one chiller water vapor condensation module configured for dewatering ambient air and for conveying dewatered air to the at least one pendulum driven dynamic compressor module 104 and at least one rotating ring dynamic compressor module compressed air drive apparatus compressed air drive apparatus 400; at least one water treatment system module 294 configured for treating condensed water vapor; at least one carbon dioxide scrubber 440 configured for sequestering carbon dioxide gas from dynamically compressed air and configured for storing the sequestered carbon dioxide gas in removable vessels; and; housing pendulum powered energy and water modules and devices in a container for creating at least one portable containerized pendulum powered energy and water device 1210.

In an embodiment the at least one anti-dampening module 260 is configured for determining a value of the at least one pendulum module 280 dampened force reduction on each swing and configured for imparting an additional force equal to the determined value of the dampened force reduction for regulating oscillations of the at least one pendulum module 280. In another embodiment the at least one pendulum driven dynamic compressor module 104 is configured for conveying compressed air into the at least one compressed air storage module 250. In an embodiment the at least one rotating ring dynamic compressor module compressed air drive apparatus is configured to use compressed air released from the at least one compressed air storage module 250 to a predetermined pressure to regulate a predetermined rotational speed for dynamically compressing air to a predetermined pressure and storing the dynamically compressed air in at least one compressed air storage module 250. In one embodiment the at least one anti-dampening module 260 is configured for injecting into at least one piston power impulse module 264 drive including at least one double acting piston power impulse module compressed air from the at least one compressed air storage module 250 at a regulated pressure to add a force driving a piston and piston rod for applying an additional force to at least one pendulum rocker arm module 270 coupled to at least one pendulum module 280 to transfer a force to the at least one pendulum module 280 to counteract a dampening force reduction for regulating oscillations.

The foregoing has described the principles, embodiments and modes of operation of the present invention. However, the invention should not be construed as being limited to the particular embodiments discussed. The above described embodiments should be regarded as illustrative rather than restrictive, and it should be appreciated that variations may be made in those embodiments by workers skilled in the art without departing from the scope of the present invention as defined by the following claims.

What is claimed is:

1. A method, comprising:
operating at least one pendulum module coupled to at least one anti-dampening module for regulating oscillations;
using the at least one pendulum module oscillations to create rotational motion in at least one pendulum pulley;
operating at least one pendulum driven dynamic compressor module housed in a dewatered air intake cabinet using the at least one pendulum module produced at least one pendulum pulley rotational motion for dynamically compressing air and storing the dynamically compressed air in at least one compressed air storage module;
rotating at least one rotating ring dynamic compressor module compressed air drive apparatus housed in a dewatered air intake cabinet using compressed air released from the at least one compressed air storage module to a predetermined pressure to regulate a predetermined rotational speed for dynamically compressing air to a predetermined pressure and storing the dynamically compressed air in at least one compressed air storage module;
creating a vacuum within at least one dewatered air intake cabinet using an outlet flow of compressed air;
creating an inlet flow of dewatered air from at least one chiller water vapor condensation module to fill the vacuum created in at least one dewatered air intake cabinet;
regulating an outlet pressure of the dynamically compressed air released from the at least one compressed air storage module to a reduced pressure for operating at least one compressed air driven piston electric generator module for generating electricity, rotating the at least one rotating ring dynamic compressor module compressed air drive apparatus, operating at least one liquid pump for pumping the at least one chiller water vapor condensation module produced liquid water, operating the at least one anti-dampening module and operating at least one liquid pump for circulating a fluid in at least one chiller water vapor condensation module;
operating the at least one chiller water vapor condensation module for dewatering ambient air drawn in through the inlet flow of dewatered air to fill the vacuum created in the at least one dewatered air intake cabinet for producing liquid water;
operating at least one water treatment system module for treating the at least one chiller water vapor condensation module produced liquid water;
sequestering carbon dioxide gas using at least one carbon dioxide scrubber from the dynamically compressed air and storing the carbon dioxide gas in removable vessels for non-release uses; and;
housing pendulum powered energy and water modules and devices in a container for creating at least one portable containerized pendulum powered energy and water device.

2. The method of claim 1, wherein the at least one anti-dampening module is configured for determining a value of the at least one pendulum module dampened force reduction on each swing and configured for imparting an additional force equal to the determined value of the dampened force reduction for regulating oscillations of the at least one pendulum module.

3. The method of claim 1, wherein the at least one pendulum driven dynamic compressor module is configured for conveying compressed air into the at least one compressed air storage module.

4. The method of claim 1, wherein the at least one rotating ring dynamic compressor module compressed air drive apparatus is configured for conveying compressed air into the at least one compressed air storage module.

5. The method of claim 1, wherein the compressed air in the at least one compressed air storage module is configured for discharging compressed air through a pressure regulator for regulating the pressure to outflow piping.

6. The method of claim 1, wherein the at least one pendulum driven dynamic compressor module and the at least one rotating ring dynamic compressor module compressed air drive apparatus are configured to be housed in separate dewatered air intake cabinets.

7. The method of claim 1, wherein the at least one pendulum driven dynamic compressor module and the at least one rotating ring dynamic compressor module compressed air drive apparatus are configured for creating a vacuum within at least one dewatered air intake cabinet causing an air flow through the at least one chiller water vapor condensation module to fill the vacuum created and the at least one chiller water vapor condensation module is configured to channel the vacuum created air flow to pass over condensation coils containing a chilled flow to reduce the air temperature to or below the dew point to cause water vapor to condense into a liquid.

8. The method of claim 1, further comprising a temperature exchanger wherein regulating the outlet pressure of the dynamically compressed air released from the at least one compressed air storage module to a reduced pressure reduces temperatures of the released compressed air and the reduced pressure released compressed air is configured to pass through the temperature exchanger configured for chilling a fluid flowing through piping coils of the temperature exchanger.

9. The method of claim 1, wherein the at least one anti-dampening module is configured for injecting into at least one piston power impulse module drive compressed air from the at least one compressed air storage module at a regulated pressure to add a force driving a piston and piston rod for applying an additional force to at least one pendulum rocker arm module coupled to at least one pendulum module to transfer a force to the at least one pendulum module to counteract a predetermined value of a dampening force reduction for regulating oscillations of the at least one pendulum module to an initial full oscillation swing.

10. The method of claim 1, wherein the at least one anti-dampening module is configured to include at least one piston power impulse module configured to include a double acting piston module for counteracting a dampening force reduction for regulating oscillations of the at least one pendulum module.

11. An apparatus, comprising:
at least one pendulum module coupled to at least one anti-dampening module configured for regulating oscillations;
at least one pendulum module configured for converting at least one pendulum module oscillations to rotational motion in at least one pendulum pulley;
at least one pendulum driven dynamic compressor module housed in a dewatered air intake cabinet configured for compressing air using rotational power produced in the at least one pendulum pulley;
at least one compressed air storage module configured for storing and releasing compressed air from at least one pendulum driven dynamic compressor module;
at least one rotating ring dynamic compressor housed in a dewatered air intake cabinet configured for using compressed air from the at least one compressed air storage module for rotating at a predetermined rotational speed for dynamically compressing air to a predetermined pressure;
at least one compressed air storage module coupled with at least one pressure regulator configured for storing compressed air and releasing compressed air at one or more regulated pressures;
at least one electric generator module configured to operate using at least one compressed air driven piston drive using pressure regulated compressed air released from the at least one compressed air storage module;
at least one chiller water vapor condensation module configured for dewatering ambient air drawn by the at least one pendulum driven dynamic compressor module and at least one rotating ring dynamic compressor and configured for producing liquid water;
at least one water treatment system module configured for treating the liquid water produced by the at least one chiller water vapor condensation module;
at least one carbon dioxide scrubber configured for sequestering carbon dioxide gas from dynamically compressed air from the at least one pendulum driven dynamic compressor module and at least one rotating ring dynamic compressor and configured for storing the sequestered carbon dioxide gas in removable vessels for non-release uses; and;
housing pendulum powered energy and water modules and devices in a container for creating at least one portable containerized pendulum powered energy and water device.

12. The apparatus of claim 11, wherein the at least one anti-dampening module is configured for determining a value of the at least one pendulum module dampened force reduction on each swing and configured for imparting an additional force equal to the determined value of the dampened force reduction for regulating oscillations of the at least one pendulum module.

13. The apparatus of claim 11, wherein the at least one pendulum driven dynamic compressor module is configured for conveying compressed air into the at least one compressed air storage module.

14. The apparatus of claim 11, wherein the at least one rotating ring dynamic compressor module compressed air drive apparatus is configured for conveying compressed air into the at least one compressed air storage module.

15. The apparatus of claim 11, wherein the at least one anti-dampening module is configured for injecting into at least one piston power impulse module drive including at least one double acting piston power impulse module drive compressed air from the at least one compressed air storage module at a regulated pressure to add a force driving a piston and piston rod for applying an additional force to at least one pendulum rocker arm module coupled to at least one pendulum module to transfer a force to the at least one pendulum module for regulating oscillations and to counteract a dampening force reduction.

16. An apparatus, comprising:
at least one pendulum module;
at least one anti-dampening module coupled to the at least one pendulum module;
at least one pendulum module configured for converting at least one pendulum module oscillations to rotational motion in at least one pendulum pulley;
at least one pendulum driven dynamic compressor module housed in a dewatered air intake cabinet and configured for dynamically compressing air using rotational power produced in the at least one pendulum pulley;
at least one compressed air storage module configured for storing dynamically compressed air and releasing pressure regulated dynamically compressed air;
at least one rotating ring dynamic compressor housed in a dewatered air intake cabinet configured for rotating at a predetermined rotational speed for dynamically compressing air to a predetermined pressure;
at least one compressed air storage module coupled with at least one pressure regulator configured for storing dynamically compressed air and releasing pressure regulated dynamically compressed air;
at least one electric generator module configured for using pressure regulated dynamically compressed air for operating at least one compressed air driven piston drive for operating;
at least one chiller water vapor condensation module configured for dewatering ambient air and for conveying dewatered air to the at least one pendulum driven dynamic compressor module and at least one rotating ring dynamic compressor;
at least one water treatment system module configured for treating condensed water vapor;
at least one carbon dioxide scrubber configured for sequestering carbon dioxide gas from dynamically compressed air and configured for storing the sequestered carbon dioxide gas in removable vessels; and;
housing pendulum powered energy and water modules and devices in a container for creating at least one portable containerized pendulum powered energy and water device.

17. The apparatus of claim 16, wherein the at least one anti-dampening module is configured for determining a value of the at least one pendulum module dampened force reduction on each swing and configured for imparting an additional force equal to the determined value of the dampened force reduction for regulating oscillations of the at least one pendulum module.

18. The apparatus of claim 16, wherein the at least one pendulum driven dynamic compressor module is configured for conveying compressed air into the at least one compressed air storage module.

19. The apparatus of claim 16, wherein the at least one rotating ring dynamic compressor module compressed air drive apparatus is configured to use compressed air released from the at least one compressed air storage module to a predetermined pressure to regulate a predetermined rotational speed for dynamically compressing air to a predetermined pressure and storing the dynamically compressed air in at least one compressed air storage module.

20. The apparatus of claim 16, wherein the at least one anti-dampening module is configured for injecting into at least one piston power impulse module drive including at least one double acting piston power impulse module compressed air from the at least one compressed air storage module at a regulated pressure to add a force driving a piston and piston rod for applying an additional force to at least one pendulum rocker arm module coupled to at least one pendulum module to transfer a force to the at least one pendulum module to counteract a dampening force reduction for regulating oscillations.
